(19) United States
(12) Patent Application Publication
(10) Pub. No.: US 2015/0339657 A1
(43) Pub. Date: Nov. 26, 2015

(54) Anti-fraud computer implemented method for financial card transaction

(71) Applicants: Nagender Aneja, Brunei (BN); Sandhya Aneja, Brunei (BN)

(72) Inventors: Nagender Aneja, Brunei (BN); Sandhya Aneja, Brunei (BN)

(21) Appl. No.: 14/285,640

(22) Filed: May 23, 2014

(51) Int. Cl. G06Q 20/32; G06Q 20/40

(52) U.S. Cl. CPC G06Q 20/3226; G06Q 20/405; G06Q 20/3255; G06Q 20/3223

(57) ABSTRACT

A computer implemented method for a financial transaction via a financial card which by default is in blocked state is described. The method comprises receiving a request in form of a message to unblock the financial card for a predetermined duration. The request is received from an electronic communicating device (ECD) by a financial institution server (FIS). The electronic communicating device has a number wherein the number is registered with the financial card. On receiving the request, the financial institution server verifies the request and genuineness of the user and after verification authorizes the request and the financial card gets unblocked for the predetermined duration.

### FIELD OF THE DISCLOSURE

The present invention relates to a system and method for locking/unlocking a mobile banking function, and more particularly, to a system and method for locking/unlocking a mobile banking function using a short message service (SMS) message.

### BACKGROUND OF THE DISCLOSURE

In general, a variety of mobile communication terminals such as mobile phones. PCS terminals, and PDA phones, support a variety of banking functions, such as user's card price inquiry and settlement, account balance inquiry, deposit transfer and remittance. The services offered by the mobile terminals are very user friendly and are being used very well in many parts of world. For doing any financial transaction, one has to have a card or various nos. and a PIN no. attached with it. While doing the transaction these details are asked and after entering the details the transaction gets executed. In many types of cards, for example, the PIN is not asked i.e. if someone has access to the card only, the person can perform the transaction.

There have been many instances where the cards have been accessed wrongfully and also the PIN attached with it. In many transactions the PIN is not required and therefore wrongfully procuring the cards would be sufficient to do the wrongful transaction.

Various attempts have been made to address the above-mentioned problems but still there exists a need of a secured financial transaction system and method. The system and method required should be simple and trouble free.

### SUMMARY OF THE DISCLOSURE

The general purpose and object of the present disclosure is to provide a secured financial transaction system and method. The system and method should also be simple and trouble free.

To achieve the above objectives, in an aspect of the present disclosure, a computer implemented method for a financial transaction via a financial card, the financial card which is by default is in blocked state, is described. The method comprises receiving a request in from of a message to unblock the financial card for a predetermined duration, the request is being received from an electronic communicating device by a financial institution server. The electronic communicating device has a number, wherein the number is registered with the financial card. On receiving the request, the financial institution server verifies the genuineness of the user. After verification, the financial institution server authorizes the request and the financial card gets unblocked for the predetermined duration.

In another embodiment, a computer readable medium bearing a computer executable instructions, wherein the computer executable instructions are executed by a processor, the processor retrieves request in form of a message from an electronic communicating device via a wireless medium to carry out a method for a financial transaction via a financial card, the financial card is by default is in blocked state, is described. The method comprises receiving a request in form of a message to unblock the financial card for a predetermined number of transactions. The request is being received from the said electronic communicating device by a financial institution server. The electronic communicating device has a registered number with the financial card. On receiving the request, the financial institution server verifies the genuineness genuineness the user. After verification, the financial institution server authorizes the request and the financial card gets unblocked for the predetermined number of transactions.

In yet another embodiment, a computer based system for managing financial transactions of a financial card, the financial card is by default in a blocked state, is described. The system comprises a component configured to receive a request in form of a message to unblock the financial card for a predetermined number of transactions. The request is being received from an electronic communicating device having a number by a financial institution server wherein the number is registered with the financial card. On receiving the request, the financial institution server verifies the genuineness of the user. After verification, the financial institution server authorizes the request and the financial card gets unblocked for the predetermined number of transactions.

These together with the other aspects of the present disclosure, along with the various features of novelty that characterize the present disclosure, are pointed out with particularity in the description, along with the above mentioned summary, annexed hereto and form a part of the present disclosure. For a better understanding of the present disclosure, its operating advantages and the specified object attained by its uses, reference should be made to the accompanying drawings and descriptive matter in which there are illustrated exemplary embodiment of the present disclosure.

### BRIEF DESCRIPTION OF THE DRAWINGS

The advantages and features of the present disclosure shall be better understood with reference to the following detailed description taken in conjunction with the accompanying drawings, wherein like elements are identified with like symbols and in which:

FIG. 1 illustrates a block diagram view of a computer implemented method of financial transaction in accordance with an exemplary embodiment of the present disclosure;

FIG. 2 illustrates a computer based system for managing financial transactions of a financial card, in accordance with an exemplary embodiment of the present disclosure; and

FIG. 3 illustrates the computer based system for managing financial transactions of a financial card, in online shopping transaction in accordance with an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description in connection with the above-mentioned drawings. Although the present disclosure is described in connection with exemplary embodiment, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the present disclosure. Further, it will nevertheless be understood that no limitation in the scope of the disclosure is thereby intended, such alterations and further modifications in the figures and such further applications of the principles of the disclosure as illustrated therein being contemplated as would normally occur to one skilled in the art to which the disclosure relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the disclosure. Furthermore, the appearances of such phrase at various places herein are not necessarily all referring to the same embodiment. The terms “a” and “an” herein do not denote a limitation of quantity, but rather denote the presence of at least one of the referenced item.

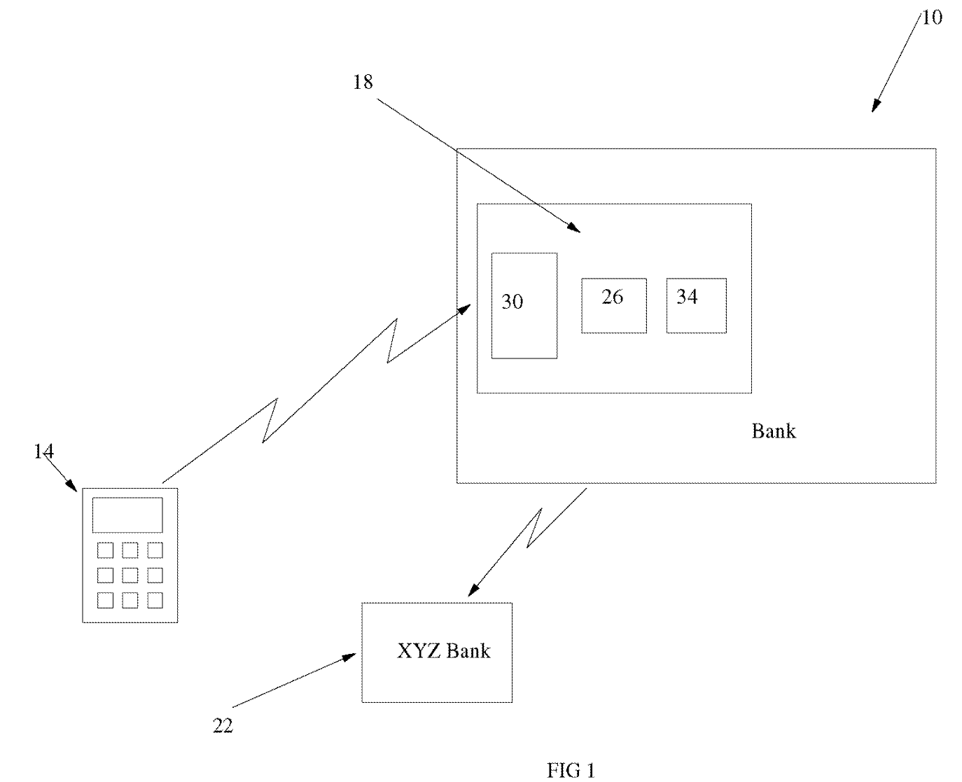

Referring to FIG. 1, a computer based system for managing financial transactions (hereinafter system (10)) has been described. The said system (10) is configured to manage the financial transaction. The major components of the system (10) are an electronic communication device (14), a financial institution server (18) and a financial card (22). The electronic communication device (14) is communicably coupled to the financial institution server (18).

The financial institution server (18) is usually located inside a bank premises but in some of the embodiments the financial institution server (18) can be located outside the bank as well.

The electronic communication device (14) can be at least one of pager, mobile phones. Tab, smart phones or any other electronic communicating device capable of sending short messaging for example SMS. The electronic communication device (14) has a SIM card having a registered number (usually phone no.). This number is registered with the financial card (22). The SIM card is placed or is inbuilt inside the electronic communication device (14).

The financial card (22) can be any of debit card, credit card, shopping card or any card capable that has the capability of storing financial values. The financial card (22) carries a personal identification number (PIN) which is to be kept secret by the user and should not be disclosed to others. By default state of the financial card (22) is blocked state. The blocked state signifies that no financial transaction can be done by the financial card.

In an operation, when the user has to do a financial transaction using the financial card (22) the user sends a message (SMS) to the financial institution server (18). The message can be in the form of particular code or request.

Examples of the message may be as follows:

<PIN no. of the financial card><no. of hours the financial card should be unblocked>

<PIN no. of the financial card><no. of transactions the financial card should be unblocked>

<PIN no. of the financial card><max. amount of the financial transaction to be done by the financial card>

It is evident from the examples that the user requests the financial institution server (18) in the form of SMS to unblock his financial card (22) for particular duration or for no. of transactions or for particular amount or financial value.

It should be appreciated that the above mentioned message format is not fixed and can be changed depending upon the usability of the user. Further, in the message format, any no. of parameters can be used and sent to the financial institution server (18) but the message should contain the PIN because the PIN is secret to the user only. The correct PIN in the message establishes the genuineness of the user who sends message from the registered no. of SIM. The use of correct PIN corresponding to the registered no. establishes the genuineness of the user. The other parameters that can be used while sending SMS are the financial card no., the last four digit of the financial card no., CVV no. of the financial card etc. The code can be sent in any format as well. The format should be acceptable to the Financial Institution Server (18).

On receiving the message, the financial institution server (18) verifies whether the message has been sent from the genuine user. The financial institution server (18) is basically a banking server that comprises a computer readable medium, the computer readable medium is various kinds of computer related software. The computer readable medium bears a computer executable instructions, the computer executable instructions are executed by at least one of the plurality of processor (hereinafter processor (26), the processor (26) retrieves request from the electronic communicating device (14) via a wireless medium to carry out the financial transaction via the financial card (22).

The financial institution server (18) is comprised of receiver transmitter module (30) and memory (34) and at least one of the plurality of processor (26).

The processor basically matches the PIN no. sent from the corresponding number (usually the phone no.) from which the SMS is sent. Once it is established that the PIN no. is sent from the registered no (usually the phone no.), the genuineness of the user is established hence the financial institution server (18) verifies the user and the request is accepted.

The acceptance of the request may be varied. For example if the request is for unblocking the financial card (22) for specified duration, the financial card (22) will be unblocked for the specified duration. If the request is for unblocking the financial card (22) for specified nos. of transaction, the financial card will be unblocked for the specified specified nos. of transaction. If the request is for unblocking the financial card (22) is for specified amount of transaction, the financial card will be unblocked for the specified amount of transaction.

If the financial institution server (18) disapproves the verification, the request is turned down and the financial card (22) remains blocked. The user will have to again send the correct message including correct PIN to the financial institution server (18). Provisions such as the user has exceeded the limit of sending wrong messages the financial card (22) will permanently get blocked and to restore its feature the user has to visit the bank. Similarly many features can also be added in the financial card (22) or the system (10) to enhance the security.

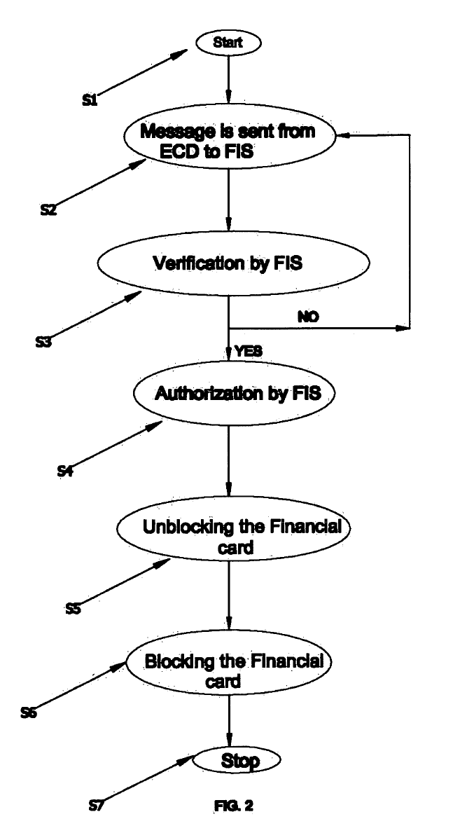

FIG. 2 summaries the financial transaction between the electronic communicating device (14), the financial institution server (18) and the financial card (22).

The method starts at S1

at S2 request in form of message is sent from the electronic communicating device (14) to the financial institution server (18)

at S3 the financial institution server (18) verifies the request by checking the PIN no. and registered no. (usually the phone no.)

at S4 the financial institution server (18) authorizes the request, if not the financial card (22) remains blocked and process will not proceed further

at S5 the financial card (22) gets unblocked

at S6 the financial card (22) gets again blocked

at S7 the method stops.

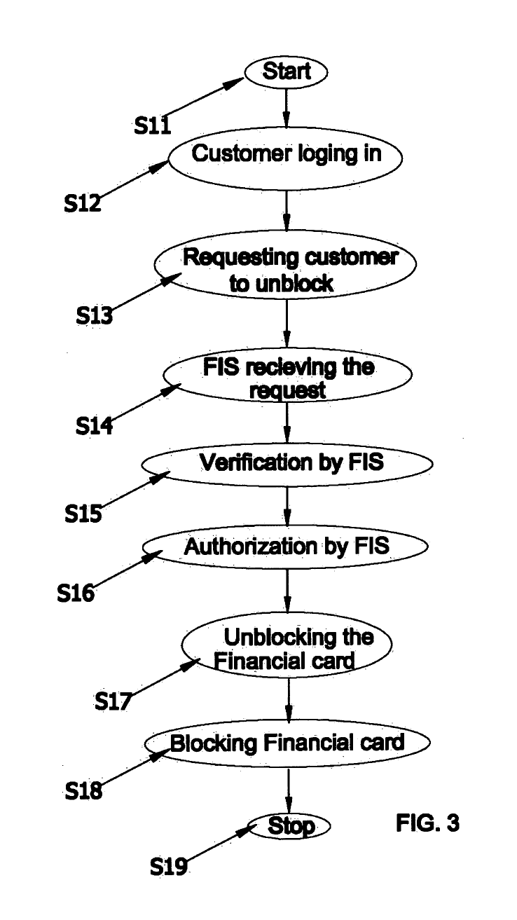

Many other embodiments of the present disclosure are also envisioned. For example the financial transaction between the electronic communicating device (14), the financial institution server (18) and the financial card (22) can be well suited as shown in FIG. 3.

The process starts at S11

at S12 customer login for shopping at retail website using ID and password

at S3 the customer request to unblock the financial card (22) for certain period sent by SMS using electronic communication device (14)

at S4 the financial institution server (18) receives the request

at S5 the financial institution server (18) verifies the request by checking the PIN no. and registered no. (usually the phone no.)

at S6 the financial institution server (18) authorizes the request, if not the financial card (22) remains blocked and process will not proceed further

S7 the financial card (22) gets unblocked for the particular time period requested

at S8 the financial card (22) gets again blocked

at S9 the method stops.

The present disclosure is advantageous in providing a secured financial transaction system and method. The system and method is simple and trouble free also.

The foregoing descriptions of specific embodiment of the present disclosure have been presented for purposes of illustration and description. They are not intended to be exhaustive or to limit the present disclosure to the precise forms disclosed and obviously many modifications and variations are possible in light of the above teaching. The embodiments were chosen and described in order to best explain the principles of the present disclosure and its practical application, to thereby enable others skilled in the art to best utilize the present disclosure and various embodiment with various modifications as are suited to the particular use contemplated. It is understood that various omission and substitutions of equivalents are contemplated as circumstance may suggest or render expedient, but such are intended to cover the application or implementation without departing from the spirit or scope of the present disclosure.

We claim:

1. A computer implemented method for a financial transaction via a financial card, the financial card is by default is in blocked state, the method comprising:
receiving a request in form of message to unblock the financial card for a predetermined duration, the request being received from an electronic communicating device by a financial institution server, wherein the electronic communicating device has a number, the number is registered with the financial card,
on receiving the request, the financial institution server verifies and after verification authorizes the request and the financial card gets unblocked for the predetermined duration.

2. The method for financial transaction via the financial card of claim 1, wherein the electronic communicating device is at least one of mobile, tab, and pager.

3. The method for financial transaction via the financial card of claim 1, wherein the request to unblock the financial card for the predetermined duration is being received via SMS from the electronic communicating device.

4. The method for financial transaction via the financial card of claim 1, wherein the message comprises last four digits of the financial card.

5. The method for financial transaction via the financial card of claim 1, wherein the message comprises number of transactions to be used by the financial card.

6. The method for financial transaction via the financial card of claim 1, wherein the message comprises amount of money to be transacted via the financial card transaction.

7. The method for financial transaction via the financial card of claim 1, wherein the message comprises CVV code.

8. A computer readable medium bearing a computer executable instructions, wherein the computer executable instructions are executed by a processor, the processor retrieves request in form of message from an electronic communicating device via a wireless medium to carry out a method for financial transaction via a financial card, the financial card is by default is in blocked state, the method comprising:
receiving a request in form of message to unblock the financial card for a predetermined number of transactions, the request being received from the said electronic communicating device by a financial institution server, wherein the electronic communicating device has a registered number with the financial card,
on receiving the request, the financial institution server verifies and after verification authorizes the request and the financial card gets unblocked for the predetermined number of transactions.

9. The method for executing the computer executable instructions for carrying out financial transaction of claim 8, wherein the electronic communicating device is at least one of mobile, tab, and pager.

10. The method for executing the computer executable instructions for carrying out financial transaction of claim 8, wherein the request to unblock the financial card for the predetermined number of financial transactions is being received via SMS from the electronic communication device.

11. The method of executing the computer executable instructions for carrying out financial transaction of claim 8, wherein the predetermined number of financial transactions is specified in the request.

12. The method of executing the computer executable instructions for carrying out financial transaction of claim 8, wherein the total money to be financially transacted in the financial transactions is requested.

13. A computer based system for managing financial transactions of a financial card, the financial card is by default in a blocked state the system comprising:
a component configured to receive a request in form of message to unblock the financial card for a predetermined number of transactions, the request being received from an electronic communicating device having a number by a financial institution server, wherein the number is registered with the financial card;
on receiving the request, the financial institution server verifies and after verification authorizes the request and the financial card gets unblocked for the predetermined number of transactions.

14. The system of claim 13, wherein the electronic communicating device is at least one of mobile, tab, and pager.

15. The system of claim 13, wherein the request to unblock the financial card for the predetermined number of transactions is being received via SMS from the electronic communicating device received by the component.

16. The system of claim 13, wherein the message further comprises the total amount of money to be withdrawn during the transactions.
